(19) United States
(12) Patent Application Publication
(10) Pub. No.: US 2023/0122682 A1
(43) Pub. Date: Apr. 20, 2023

(54) Valve piston pump body device

(71) Applicant: Lei Yu, Shenzhen (CN)

(72) Inventor: Lei Yu, Shenzhen (CN)

(21) Appl. No.: 18/066,993

(22) Filed: Dec. 15, 2022

(30) Foreign Application Priority Data
Jul. 8, 2022 (CN) 202221966871.5

(51) Int. Cl. F04B 19/04; F04B 17/00; F04B 53/14; F04B 49/12

(52) U.S. Cl. CPC F04B 19/04; F04B 17/00; F04B 53/144; F04B 49/123; A61C 17/024

(57) ABSTRACT

A valve piston pump body device of water flosser includes a front bracket shell equipped with a back bracket shell. A pump body is installed at the middle-upper end of the cavity between the front bracket shell and the back bracket shell. A motor is installed at the middle-lower end of the cavity between the front bracket shell and the back bracket shell. The rotating shaft at the upper end of the motor is equipped with motor teeth. A first metal shaft is arranged in the hole of the cavity between the front bracket shell and the back bracket shell. A driving gear is installed on the first metal shaft and the driving gear and the motor teeth are mutually engaged. A one-way valve piston device is used.

### FIELD OF THE INVENTION

The invention relates to water flossers, and more particularly to an improved valve piston pump body device of a water flosser.

### BACKGROUND OF THE INVENTION

The water flosser is an auxiliary tool for cleaning the mouth. It uses pulsed water flow to clean teeth and teeth gaps, mainly divided into a portable type and a desktop type with the general flushing pressure from 0 to 90Psi. With people's attention to oral health, water flosser has become more and more common, especially the portable water flosser. The portable water flosser is more free to use and appreciated by the majority of users due to its compact size, easier carrying and storage, no constraints on usage occasions, no need to plug in for use, and no lengthy cables like the desktop water flosser. Wherein the water pump is an essential part of the water drive of the water flosser.

The water pump of the conventional water flosser in the prior art is designed with one or two silica gel piston devices and one-way valve piece switches of the inlet and outlet devices, which repeatedly move inside the pump body to achieve the pumping structure of the water pump. However, with such a device structure, when the water flosser is not used for a long time, the valve piece dries, and the pump body in the water flosser cannot supply water, resulting in that the water flosser cannot be used normally.

Thus, the need for improvement still exists.

### SUMMARY OF THE INVENTION

The invention provides a novel valve piston pump body device, which solves the problems in the background art.

In order to accomplish the aforementioned goal, the invention offers the following technological remedy: a novel valve piston pump body device that consists of a front bracket shell and a back bracket shell. A pump body is installed at the middle-upper end of the cavity between the front bracket shell and the back bracket shell, a motor is installed at the middle-lower end of the cavity between the front bracket shell and the back bracket shell, the rotating shaft at the upper end of the motor is equipped with motor teeth, a first metal shaft is arranged in the hole of the cavity between the front bracket shell and the back bracket shell, a driving gear is installed on the first metal shaft, and the driving gear and the motor teeth are mutually engaged. The eccentric wheel of the driving gear is equipped with a connecting rod, one end of the connecting rod is equipped with a piston rod, the connecting rod and the piston rod are movably connected through a second metal shaft, one end of the piston rod is equipped with a piston head, the other end of the piston rod is equipped with a waterproof O-ring, both the piston rod and the waterproof O-ring of the piston head are movably arranged in the pump body, a first cavity is formed between the inside of the pump body, the piston rod and the piston head, a second cavity is formed between the inside of the pump body, the piston rod, the piston head and the waterproof O-ring, a drain hole is provided in the second cavity of the pump body, a water inlet adapter is installed on the upper side of the pump body, a mushroom head base is installed in the cavity of the water inlet adapter, a first spring and a mushroom head are installed between the water inlet adapter and the cavity of the mushroom head base. The first spring is fixedly connected at one end of the mushroom head, one end of the water inlet adapter is equipped with a water inlet pipe, the other end of the water inlet pipe is equipped with a water inlet pipe adapter. Also, the other end of the water inlet pipe adapter is equipped with a first waterproof O-ring, a drain pipe that is installed at the drain hole of the second cavity of the pump body, a drain pipe adapter is installed at the other end of the drain pipe, and a second waterproof O-ring that is installed at the other end of the drain pipe adapter. After prolonged usage, the first cavity's water seeps into the second cavity, where it is subsequently drained by the second cavity's drain hole, drain pipe, and drain pipe adapter. A nozzle base is installed on the upper side of the pump body, a second spring and a water outlet valve piece are installed between the lower end of the nozzle base and the cavity at the upper end of the pump body, and the second spring is arranged on the other side of the water outlet valve piece to connect and fix in sequence, a locking plate is installed on the upper end of the nozzle base, a fifth waterproof O-ring is installed between the inner cavity of the upper end of the nozzle base and the lower end of the locking plate, and a high-pressure nozzle is installed on the fifth waterproof O-ring of the locking plate of the nozzle base.

In addition, the drive mechanism comprises a motor, motor teeth, a first metal shaft, a driving gear, and a connecting rod, and a motor installed at the lower end of the cavity between the front bracket shell and the back bracket shell, wherein, the motor teeth are installed on the upper end rotating shaft of the motor, the first metal shaft is installed in the middle cavity hole of the front bracket shell and the back bracket shell, the driving gear is installed on the first metal shaft, the driving gear and the motor teeth are mutually engaged, the connecting rod is installed on the eccentric wheel of the driving gear, and a plurality of bone positions are provided on both sides of the middle cavity of the front bracket shell and the back bracket shell, making the connecting rod moves up and down only without swinging left and right.

Also, the second metal shaft serves as the moving connection between the connecting rod and the piston rod, and the appropriate places of the connecting rod and piston rod are equipped with installation holes for the second metal shaft.

Furthermore, one end of the piston rod is equipped with a piston head, the other end of the piston rod is equipped with a waterproof O-ring, both the piston rod and the waterproof O-ring of the piston head are movably arranged in the pump body, a first cavity is formed between the inside of the pump body, the piston rod, and the piston head, and a second cavity is formed between the inside of the pump body, the piston rod, the piston head, and the waterproof O-ring.

Additionally, the second cavity of the pump body has a drain hole. Furthermore, a water inlet adapter is installed on the upper side of the pump body, a mushroom head base is installed in the cavity of the water inlet adapter, a first spring and a mushroom head are installed between the water inlet adapter and the cavity of the mushroom head base, and the first spring is fixedly connected at one end of the mushroom head.

A drain pipe is also fitted at the drain hole of the pump body's second cavity, a drain pipe adapter is installed at the other end of the drain pipe, and a second waterproof O-ring is installed at the other end of the drain pipe adapter. Moreover, the water inlet adapter has a water inlet pipe arranged at one end, a water inlet pipe adapter attached to the other end of the water inlet pipe, and a first waterproof O-ring attached to the other end of the water inlet pipe adapter. Furthermore, a nozzle base is arranged on the upper side of the pump body, a second spring and a water outlet valve piece are installed between the lower end of the nozzle base and the cavity at the upper end of the pump body, and the second spring is arranged on the other side of the water outlet valve piece to connect and fix in sequence.

Besides, a locking plate is installed on the upper end of the nozzle base, a fifth waterproof O-ring is installed between the inner cavity of the upper end of the nozzle base and the lower end of the locking plate, and a high-pressure nozzle is installed on the fifth waterproof O-ring of the locking plate of the nozzle base.

The invention provides a novel valve piston pump body device that has the following benefits over the previous art: The novel valve piston pump body device is equipped with a first spring to push the mushroom head plug to seal the water inlet and a second spring to push the water outlet valve piece to seal the water outlet on the top of the pump body. Thus, the one-way valve piston device is used in the water flosser, strengthening the sealing of the water inlet valve and solving the problems as follows: when the water flosser is not used for a long time, the valve piece dries, resulting in poor sealing and water feeding, and the valve piece is broken down after the water flosser is used for a long time. The invention makes the water feeding of the water flosser stable, ensures the sealing property of the water flosser, and extends the service life.

The above and other objects, features and advantages of the invention will become apparent from the following detailed description taken with the accompanying drawings

### BRIEF DESCRIPTION OF THE DRAWINGS

FIG. 1 is a side elevation of the invention;

FIG. 2 is an exploded view of the invention;

FIG. 3 is a longitudinal sectional view of the invention;

FIG. 4 is a top sectional view of the pump body of the invention; and

FIG. 5 is a sectional view of the adapter of the invention.

### DETAILED DESCRIPTION OF THE INVENTION

The following will provide a clear and comprehensive description of the technological solutions used in the invention's embodiments in conjunction with the figures. Obviously, the described embodiments are only part of the embodiments of the invention, but not all of them. Based on the embodiments of the invention, all other embodiments obtained by ordinary technicians in the art without making creative labor shall fall within the scope of protection of the invention.

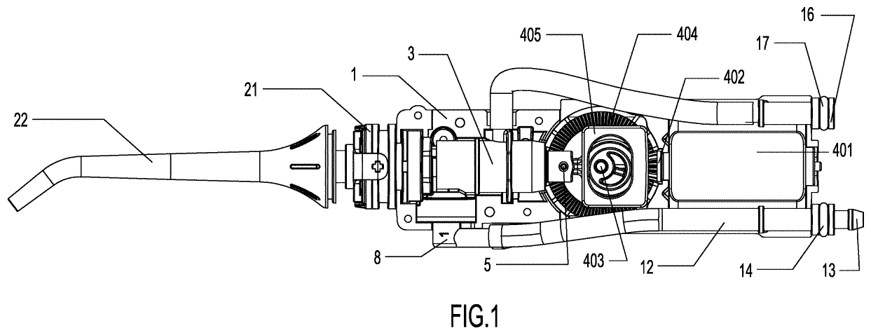

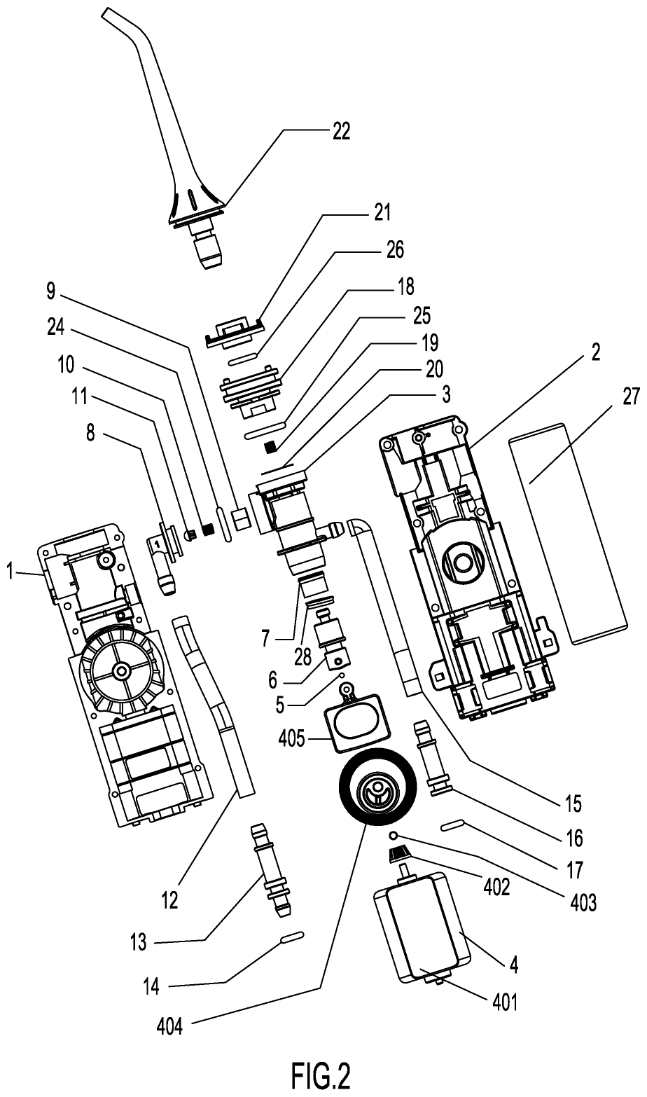

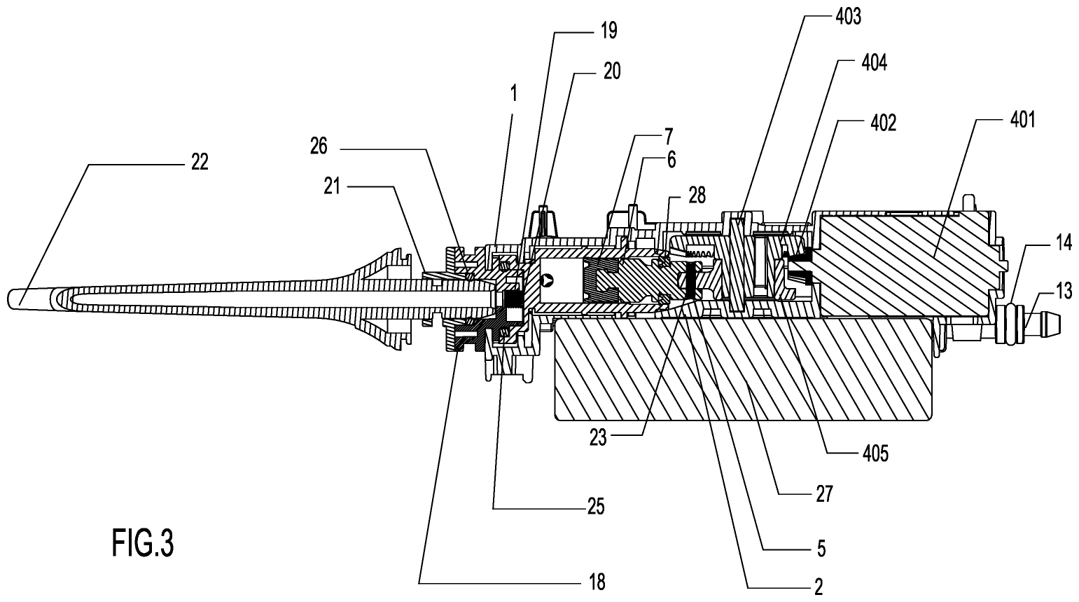

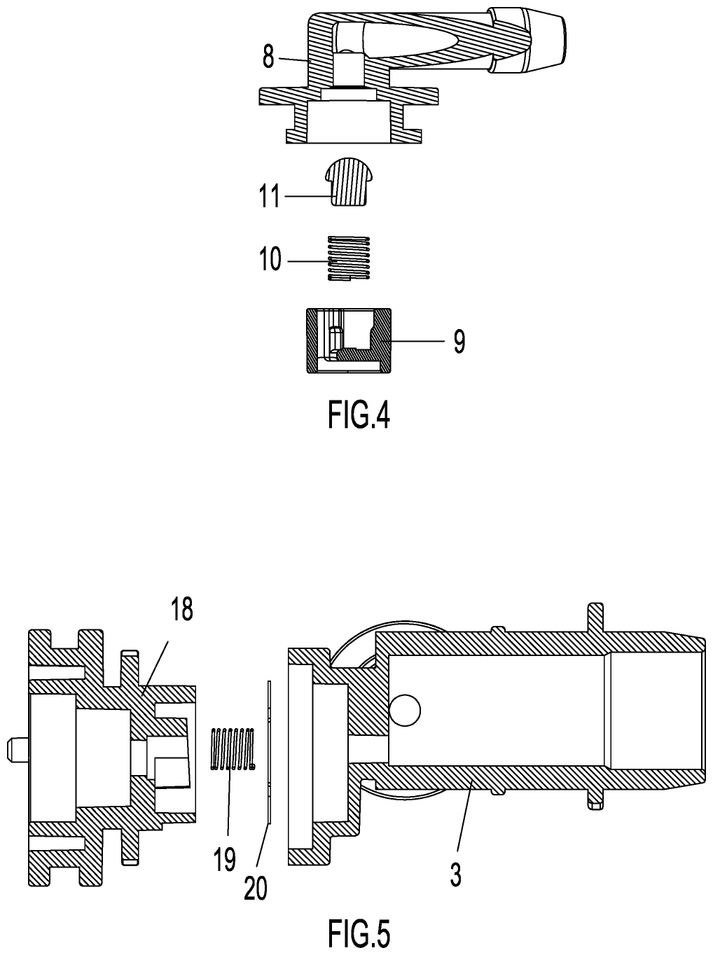

Referring to FIGS. 1 to 5, a valve piston pump body device of the invention comprises a front bracket shell 1, wherein, the front bracket shell 1 is equipped with a back bracket shell 2, a pump body 3 is installed at the middle-upper end of the cavity between the front bracket shell 1 and the back bracket shell 2, a drive mechanism 4 is installed at the middle-lower end of the cavity between the front bracket shell 1 and the back bracket shell 2, the rotating shaft at the upper end of the motor 401 is equipped with motor teeth 402, a first metal shaft 403 is arranged in the hole of the cavity between the front bracket shell 1 and the back bracket shell 2, a driving gear 404 is installed on the first metal shaft 403, and the driving gear 404 and the motor teeth 402 are mutually engaged. The eccentric wheel of the driving gear 404 is equipped with a connecting rod 405, one end of the connecting rod 405 is equipped with a piston rod 6, the connecting rod 405 and the piston rod 6 are movably connected through a second metal shaft 5, one end of the piston rod 6 is equipped with a piston head 7, the other end of the piston rod 6 is equipped with a waterproof O-ring 28, both the piston rod 6 and the waterproof O-ring 28 of the piston head 7 are movably arranged in the pump body 3, a drain hole is arranged in the second cavity of the pump body 3, a water inlet adapter 8 is arranged on the upper side of the pump body, a mushroom head base 9 is installed in the cavity of the water inlet adapter 8, a first spring 10 and a mushroom head 11 are installed between the water inlet adapter 8 and the cavity of the mushroom head base 9, the first spring 10 is fixedly connected at one end of the mushroom head 11, one end of the water inlet adapter 8 is equipped with a water inlet pipe 12, the other end of the water inlet pipe 12 is equipped with a water inlet pipe adapter 13, the other end of the water inlet pipe adapter 13 is equipped with a first waterproof O-ring 14, a drain pipe 15 is installed at the drain hole of the second cavity of the pump body 3, a drain pipe adapter 16 is installed at the other end of the drain pipe 15, a second waterproof O-ring 17 is installed at the other end of the drain pipe adapter 16, a nozzle base 18 is installed on the upper side of the pump body 3, a second spring 19 and a water outlet valve piece 20 are installed between the lower end 18 of the nozzle base and the cavity at the upper end of the pump body 3, the second spring 19 is arranged on the other side of the water outlet valve piece 20 to connect and fix in sequence, a locking plate 21 is installed on the upper end of the nozzle base 18, a fifth waterproof O-ring 26 is installed between the inner cavity of the upper end of the nozzle base 18 and the lower end of the locking plate 21, and a high-pressure nozzle 22 is installed on the fifth waterproof O-ring 26 of the locking plate 21 of the nozzle base 18.

Specifically, the drive mechanism 4 comprises a motor 401, motor teeth 402, a first metal shaft 403, a driving gear 404 and a connecting rod 405, and a motor 401 installed at the lower end of the cavity between the front bracket shell 1 and the back bracket shell 2, wherein, the motor teeth 402 are installed on the upper end rotating shaft of the motor 401, the first metal shaft 403 is installed in the middle cavity hole of the front bracket shell 1 and the back bracket shell 2, the driving gear 404 is installed on the first metal shaft 403, the driving gear 404 and the motor teeth 402 are mutually engaged, the connecting rod 405 is installed on the eccentric wheel of the driving gear 404, and the connecting rod 405 and the first metal shaft 403 are movably connected.

In this solution, the output shaft of the motor 401 drives the motor teeth 402 to rotate, the motor teeth 402 drives the driving gear 404 to rotate, and the driving gear 404 drives the connecting rod 405 to move up and down only without swinging left and right, so that the connecting rod 405 drives the piston rod 6 to move up and down.

Specifically, the corresponding positions of the connecting rod 405 and the piston rod 6 are provided with installation holes for installing the second metal shaft 5.

In this solution, the installation holes are used for conveniently and movably inserting the second metal shaft 5 into the connecting rod 405 and the piston rod 6 for the connection of the two.

Specifically, a third waterproof O-ring 24 is arranged between the upper surface of the water inlet adapter 8 and the pump body 3.

In this solution, the third waterproof O-ring 24 better seals the upper surface of the water inlet adapter 8 and the pump body 3.

Specifically, the lower end of the nozzle base 18 is inserted into the pump body 3, and the fourth waterproof O-ring 25 is arranged between the right edge of the outer surface of the nozzle base 18 and the cavity at the upper end of the pump body 3.

In this solution, the fourth waterproof O-ring 25 better seals the nozzle base 18 and the pump body 3, without water leakage.

Specifically, the fifth waterproof O-ring 26 is arranged between the outer surface of the high-pressure nozzle 22 and the left side surface of the locking plate 21, and the left inner wall of the nozzle base 18 with better sealing and without water leakage.

In this solution, the fifth waterproof O-ring 26 better seals the high-pressure nozzle 22, locking plate 21 and nozzle base 18.

Specifically, the front side of the front bracket shell 2 is provided with a battery 27 which supplies power to the motor 401.

In this solution, the battery 27 provides the motor 401 with power for convenience of use.

When used, the output shaft of the motor 401 in the drive mechanism 4 drives the motor teeth 402 to rotate, the motor teeth 402 drives the driving gear 404 to rotate, and the driving gear 404 drives the connecting rod 405 to move up and down only without swinging left and right, so that the connecting rod 405 drives the piston rod 6, the piston head 7 and the waterproof O-ring 28 move up and down. When the drive mechanism 4 makes the piston rod 6 drive the piston head 7 and the waterproof O-ring 28 moves backward in the pump body 3, the mushroom head plug 11 at the water inlet of the pump body 3 is sucked open, and the water outlet valve piece 20 sucks the water outlet of the pump body 3 more tightly to seal the water outlet, so that water enters the first cavity of the pump body 3 from the water inlet pipe 12 and the water inlet adapter 8 of the water inlet pipe adapter 13. When the drive mechanism 4 drives the piston rod 6, the piston head 7 and the waterproof O-ring 28 move forward in the pump body 3, the water outlet valve piece 20 of the pump body 3 is pushed open, and the mushroom head plug 11 at the water inlet of the pump body 3 is pushed more tightly to seal the water inlet. As a result, the water in the first cavity of the pump body 3 is forced out at high pressure and expelled through the high-pressure nozzle 22 of the locking plate 21 of the nozzle base 18.A one-way valve piston device is used in the water flosser, strengthening the sealing of the water inlet valve, and solving the problems as follows: when the water flosser is not used for a long time, the water outlet valve piece 20 dries, resulting in poor sealing and water feeding, and the water outlet valve piece 20 is broken down after the water flosser is used for a long time. The invention makes the water feeding of the water flosser stable, ensures the sealing property of the water flosser, and extends the service life. The drain hole, drain pipe 15, and drain pipe adapter 16 in the second cavity are used to remove the water that eventually seeps from the first cavity after prolonged usage.

In summary, the novel valve piston pump body device employs the one-way valve piston device to enhance the water inlet valve's sealing and address the following issues: when the water flosser is not used for a long time, the valve piece dries, resulting in poor sealing and water feeding, and the valve piece is broken down after the water flosser is used for a long time. The invention makes the water feeding of the water flosser stable, ensures the sealing property of the water flosser, and extends the service life.

While the invention has been described in terms of preferred embodiments, those skilled in the art will recognize that the invention can be practiced with modifications within the spirit and scope of the appended claims.

What is claimed is:

1. A valve piston pump body device, comprising a front bracket shell, further comprising a front bracket shell that is equipped with a back bracket shell, a pump body is installed at the middle-upper end of the cavity between the front bracket shell and the back bracket shell, a motor is installed at the middle-lower end of the cavity between the front bracket shell and the back bracket shell, the rotating shaft at the upper end of the motor is equipped with motor teeth, a first metal shaft is arranged in the hole of the cavity between the front bracket shell and the back bracket shell, a driving gear is installed on the first metal shaft, and the driving gear and the motor teeth are mutually engaged, the eccentric wheel of the driving gear is equipped with a connecting rod, one end of the connecting rod is equipped with a piston rod, the connecting rod and the piston rod are movably connected through a second metal shaft, one end of the piston rod is equipped with a piston head, the other end of the piston rod is equipped with a waterproof O-ring, both the piston rod and the waterproof O-ring of the piston head are movably arranged in the pump body, a first cavity is formed between the inside of the pump body, the piston rod and the piston head, a second cavity is formed between the inside of the pump body, the piston rod, the piston head and the waterproof O-ring, a drain hole is provided in the second cavity of the pump body, a water inlet adapter is installed on the upper side of the pump body, a mushroom head base is installed in the cavity of the water inlet adapter, a first spring and a mushroom head are installed between the water inlet adapter and the cavity of the mushroom head base, the first spring is fixedly connected at one end of the mushroom head, one end of the water inlet adapter is equipped with a water inlet pipe, the other end of the water inlet pipe is equipped with a water inlet pipe adapter, the other end of the water inlet pipe adapter is equipped with a first waterproof O-ring, a drain pipe is installed at the drain hole of the second cavity of the pump body, a drain pipe adapter is installed at the other end of the drain pipe, a second waterproof O-ring is installed at the other end of the drain pipe adapter, a nozzle base is installed on the upper side of the pump body, a second spring and a water outlet valve piece are installed between the lower end of the nozzle base and the cavity at the upper end of the pump body, the second spring is arranged on the other side of the water outlet valve piece to connect and fix in sequence, a locking plate is installed on the upper end of the nozzle base, a fifth waterproof O-ring is installed between the inner cavity of the upper end of the nozzle base and the lower end of the locking plate, and a high-pressure nozzle is installed on the fifth waterproof O-ring of the locking plate of the nozzle base.

2. The valve piston pump body device of claim 1, further comprising a drive mechanism that comprises a motor, a motor teeth, a first metal shaft, a driving gear, a connecting rod, and a motor installed at the lower end of the cavity between the front bracket shell and the back bracket shell, wherein, the motor teeth are installed on the upper end rotating shaft of the motor, the first metal shaft is installed in the middle cavity hole of the front bracket shell and the back bracket shell, the driving gear is installed on the first metal shaft, the driving gear and the motor teeth are mutually engaged, the connecting rod is installed on the eccentric wheel of the driving gear, and a plurality of bone positions are provided on both sides of the middle cavity of the front bracket shell and the back bracket shell, making the connecting rod moves up and down only without swinging left and right in the front bracket shell and the back bracket shell.

3. The valve piston pump body device of claim 1, further comprising a connecting rod and a piston rod that are movably connected through the second metal shaft, and the corresponding positions of the connecting rod and the piston rod are provided with installation holes for installing the second metal shaft.

4. The valve piston pump body device of claim 1, further comprising one end of the piston rod that is equipped with a piston head, the other end of the piston rod is equipped with the waterproof O-ring, both the piston rod and the waterproof O-ring of the piston head are movably arranged in the pump body, the first cavity is formed between the inside of the pump body, the piston rod and the piston head, the second cavity is formed between the inside of the pump body, the piston rod, the piston head and the waterproof O-ring.

5. The valve piston pump body device of claim 1, further comprising a drain hole that is provided in the second cavity of the pump body.

6. The valve piston pump body device of claim 1, further comprising a water inlet adapter that is installed on the upper side of the pump body, the mushroom head base is installed in the cavity of the water inlet adapter, the first spring and the mushroom head are installed between the water inlet adapter and the cavity of the mushroom head base, and the first spring is fixedly connected at one end of the mushroom head.

7. The valve piston pump body device of claim 1, further comprising a drain pipe that is installed at the drain hole of the second cavity of the pump body, the drain pipe adapter is installed at the other end of the drain pipe, and the second waterproof O-ring is installed at the other end of the drain pipe adapter, after long-time use, the water in the first cavity leaks to the second cavity and then is drained by the drain hole, drain pipe and the drain pipe adapter.

8. The valve piston pump body device of claim 1, wherein one end of a water inlet adapter that is equipped with a water inlet pipe, the other end of the water inlet pipe is equipped with the water inlet pipe adapter, and the other end of the water inlet pipe adapter is equipped with the first waterproof O-ring.

9. The valve piston pump body device of claim 1, further comprising a nozzle base that is installed on the upper side of the pump body, the second spring, and the water outlet valve piece are installed between the lower end of the nozzle base and the cavity at the upper end of the pump body, and the second spring is arranged on the other side of the water outlet valve piece to connect and fix in sequence.

10. The valve piston pump body device of claim 1, further comprising a locking plate that is installed on the upper end of the nozzle base, a fifth waterproof O-ring that is installed between the inner cavity of the upper end of the nozzle base and the lower end of the locking plate, as well as a high-pressure nozzle that is installed on the fifth waterproof O-ring of the locking plate of the nozzle base.
